(19) United States
(12) Patent Application Publication
(10) Pub. No.: US 2015/0088511 A1
(43) Pub. Date: Mar. 26, 2015

(54) NAMED-ENTITY BASED SPEECH RECOGNITION

(71) Applicant: Verizon Patent and Licensing Inc., Basking Ridge, NJ (US)

(72) Inventors: Sujeeth S. Bharadwaj, Chicago, IL (US); Suri B. Medapati, San Jose, CA (US)

(73) Assignee: Verizon Patent and Licensing Inc., Basking Ridge, NJ (US)

(21) Appl. No.: 14/035,845

(22) Filed: Sep. 24, 2013

(51) Int. Cl. G10L 15/187; G10L 15/06; G10L 15/22

(52) U.S. Cl. CPC G10L 15/187; G10L 15/22; G10L 15/063; G10L 2015/0631; G10L 2015/0636; G10L 2015/0638
USPC 704/244

(57) ABSTRACT

In embodiments, apparatuses, methods and storage media are described that are associated with recognition of speech based on sequences of named entities. Language models may be trained as being associated with sequences of named entities. A language model may be selected for speech recognition after identification of one or more sequences of named entities by an initial language model. After identification of the one or more sequences of named entities, weights may be assigned to the one or more sequences of named entities. These weights may be utilized to select a language module and/or update the initial language model to one that is associated with the identified one or more sequences of named entities. In various embodiments, the language model may be repeatedly updated until the recognized speech converges sufficiently to satisfy a predetermined threshold. Other embodiments may be described and claimed.

### TECHNICAL FIELD

The present disclosure relates to the field of data processing, in particular, to apparatuses, methods and systems associated with speech recognition.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Modern electronic devices, including devices for presentation of content, increasingly utilize speech recognition for control. For example, a user of a device may request a search for content or playback of stored or streamed content. However, many speech recognition solutions are not well-optimized for commands relating to content consumption. As such, existing techniques may make errors when analyzing speech received from a user. In particular, existing techniques may make errors relating to content metadata, such as names of content, actors, directors, genres, etc.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the Figures of the accompanying drawings.

FIG. 1 illustrates an example arrangement for content distribution and consumption, in accordance with various embodiments.

FIG. 2. illustrates an example process for performing speech recognition, in accordance with various embodiments.

FIG. 3 illustrates an example arrangement for training language models associated with sequences of named entities, in accordance with various embodiments.

FIG. 4 illustrates an example process for training language models associated with sequences of named entities, in accordance with various embodiments.

FIG. 5 illustrates an example arrangement for speech recognition using language models associated with sequences of named entities, in accordance with various embodiments.

FIG. 6 illustrates an example process for performing speech recognition using language models associated with sequences of named entities, in accordance with various embodiments.

FIG. 7 illustrates an example computing environment suitable for practicing various aspects of the present disclosure, in accordance with various embodiments.

FIG. 8 illustrates an example storage medium with instructions configured to enable an apparatus to practice various aspects of the present disclosure, in accordance with various embodiments.

### DETAILED DESCRIPTION

Embodiments described herein are directed to, for example, methods, computer-readable media, and apparatuses associated with speech recognition based on sequences of named entities. Named entities may, in various embodiments, include various identifiable words associated with specific meaning, such as proper names, nouns, and adjectives. In various embodiments, named entities may include predefined categories of text. In various embodiments, different categories may apply to different domains of usage. For example, in a domain where speech recognition is performed with reference to media content such categories may include categories such as actors, producers, directors, singers, baseball players, baseball teams, and so on. As another example, in the domain of travel, named entities may be defined for categories such as city names, street names, names of restaurants, gas stations, etc. In other embodiments, the speech recognition techniques described herein may be performed with reference to other types of speech. Thus, rather than using named entities, parts of speech, such as nouns, verbs, adjectives, etc., may be analyzed and utilized for speech recognition.

In various embodiments, language models may be trained as being associated with sequences of named entities. For example, a sample of text may be analyzed to identify one or more named entities. These named entities may be clustered according to their sequence in the sample text. A language model may then be trained on the sample text and associated with the identified named entities for later use in speech recognition. Additionally, in various embodiments, language models that have been trained as being associated with sequences of named entities may be used in other applications. For example, machine translation between languages may be performed based on language model training using sequences of named entities.

In various embodiments, language models associated with sequences of named entities may be utilized in speech recognition. In various embodiments, a language model may be selected for speech recognition based on one or more sequences of named entities identified from a speech sample. In various embodiments, the language model may be selected after identification of the one or more sequences of named entities by an initial language model. In various embodiments, after identification of the one or more sequences of named entities, weights may be assigned to the one or more sequences of named entities. These weights may be utilized to select a language module and/or update the initial language model to one that is associated with the identified one or more sequences of named entities. In various embodiments, the language model may be repeatedly updated until the recognized speech converges sufficiently to satisfy a predetermined threshold.

It may be recognized that, while particular embodiments are described herein with reference to identification of named entities in speech, in various embodiments, other language features may be utilized. For example, in various embodiments, nouns in speech may be identified in lieu of named entity identification. In other embodiments, only proper nouns may be identified and utilized for speech recognition.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “logic” and “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

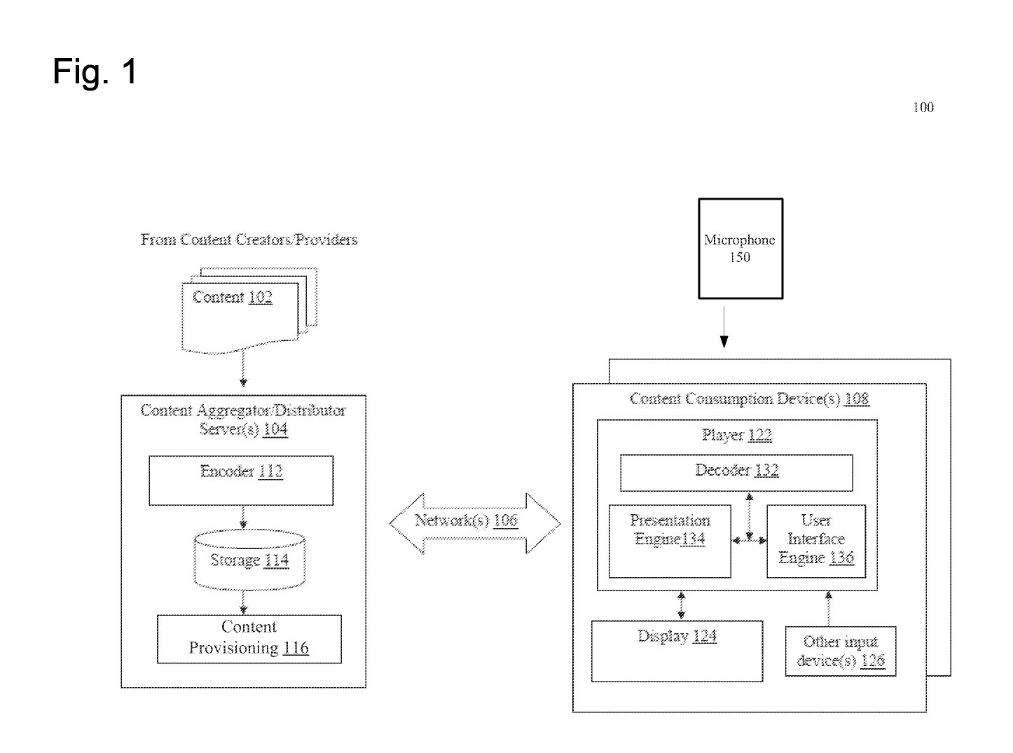

Referring now to FIG. 1, an arrangement 100 for content distribution and consumption, in accordance with various embodiments, is illustrated. As shown, in embodiments, arrangement 100 for distribution and consumption of content may include a number of content consumption devices 108 coupled with one or more content aggregator/distributor servers 104 via one or more networks 106. Content aggregator/distributor servers 104 may be configured to aggregate and distribute content to content consumption devices 108 for consumption, e.g., via one or more networks 106. In various embodiments, camera adjustment techniques described herein may be implemented in association with arrangement 100. In other embodiments, different arrangements, devices, and/or systems maybe used.

In embodiments, as shown, content aggregator/distributor servers 104 may include encoder 112, storage 114 and content provisioning 116, which may be coupled to each other as shown. Encoder 112 may be configured to encode content 102 from various content creators and/or providers 101, and storage 114 may be configured to store encoded content. Content provisioning 116 may be configured to selectively retrieve and provide encoded content to the various content consumption devices 108 in response to requests from the various content consumption devices 108. Content 102 may be media content of various types, having video, audio, and/or closed captions, from a variety of content creators and/or providers. Examples of content may include, but are not limited to, movies, TV programming, user created content (such as YouTube video, iReporter video), music albums/titles/pieces, and so forth. Examples of content creators and/or providers may include, but are not limited to, movie studios/distributors, television programmers, television broadcasters, satellite programming broadcasters, cable operators, online users, and so forth.

In various embodiments, for efficiency of operation, encoder 112 may be configured to encode the various content 102, typically in different encoding formats, into a subset of one or more common encoding formats. However, encoder 112 may be configured to nonetheless maintain indices or cross-references to the corresponding content in their original encoding formats. Similarly, for flexibility of operation, encoder 112 may encode or otherwise process each or selected ones of content 102 into multiple versions of different quality levels. The different versions may provide different resolutions, different bitrates, and/or different frame rates for transmission and/or playing. In various embodiments, the encoder 112 may publish, or otherwise make available, information on the available different resolutions, different bitrates, and/or different frame rates. For example, the encoder 112 may publish bitrates at which it may provide video or audio content to the content consumption device(s) 108. Encoding of audio data may be performed in accordance with, e.g., but are not limited to, the MP3 standard, promulgated by the Moving Picture Experts Group (MPEG). Encoding of video data may be performed in accordance with, e.g., but are not limited to, the H264 standard, promulgated by the International Telecommunication Unit (ITU) Video Coding Experts Group (VCEG). Encoder 112 may include one or more computing devices configured to perform content portioning, encoding, and/or transcoding, such as described herein.

Storage 114 may be temporal and/or persistent storage of any type, including, but are not limited to, volatile and non-volatile memory, optical, magnetic and/or solid state mass storage, and so forth. Volatile memory may include, but are not limited to, static and/or dynamic random access memory. Non-volatile memory may include, but are not limited to, electrically erasable programmable read-only memory, phase change memory, resistive memory, and so forth.

In various embodiments, content provisioning 116 may be configured to provide encoded content as discrete files and/or as continuous streams of encoded content. Content provisioning 116 may be configured to transmit the encoded audio/video data (and closed captions, if provided) in accordance with any one of a number of streaming and/or transmission protocols. The streaming protocols may include, but are not limited to, the Real-Time Streaming Protocol (RTSP). Transmission protocols may include, but are not limited to, the transmission control protocol (TCP), user datagram protocol (UDP), and so forth. In various embodiments, content provisioning 116 may be configured to provide media files that are packaged according to one or more output packaging formats.

Networks 106 may be any combinations of private and/or public, wired and/or wireless, local and/or wide area networks. Private networks may include, e.g., but are not limited to, enterprise networks. Public networks, may include, e.g., but is not limited to the Internet. Wired networks, may include, e.g., but are not limited to, Ethernet networks. Wireless networks, may include, e.g., but are not limited to, Wi-Fi, or 3G/4G networks. It would be appreciated that at the content distribution end, networks 106 may include one or more local area networks with gateways and firewalls, through which content aggregator/distributor server 104 communicate with content consumption devices 108. Similarly, at the content consumption end, networks 106 may include base stations and/or access points, through which consumption devices 108 communicate with content aggregator/distributor server 104. In between the two ends may be any number of network routers, switches and other networking equipment of the like. However, for ease of understanding, these gateways, firewalls, routers, switches, base stations, access points and the like are not shown.

In various embodiments, as shown, a content consumption device 108 may include player 122, display 124 and user input device(s) 126. Player 122 may be configured to receive streamed content, decode and recover the content from the content stream, and present the recovered content on display 124, in response to user selections/inputs from user input device(s) 126.

In various embodiments, player 122 may include decoder 132, presentation engine 134 and user interface engine 136. Decoder 132 may be configured to receive streamed content, decode and recover the content from the content stream. Presentation engine 134 may be configured to present the recovered content on display 124, in response to user selections/inputs. In various embodiments, decoder 132 and/or presentation engine 134 may be configured to present audio and/or video content to a user that has been encoded using varying encoding control variable settings in a substantially seamless manner. Thus, in various embodiments, the decoder 132 and/or presentation engine 134 may be configured to present two portions of content that vary in resolution, frame rate, and/or compression settings without interrupting presentation of the content. User interface engine 136 may be configured to receive signals from user input device 126 that are indicative of the user selections/inputs from a user, and to selectively render a contextual information interface as described herein.

While shown as part of a content consumption device 108, display 124 and/or user input device(s) 126 may be stand-alone devices or integrated, for different embodiments of content consumption devices 108. For example, for a television arrangement, display 124 may be a stand alone television set, Liquid Crystal Display (LCD), Plasma and the like, while player 122 may be part of a separate set-top set, and user input device 126 may be a separate remote control (such as described below), gaming controller, keyboard, or another similar device. Similarly, for a desktop computer arrangement, player 122, display 124 and user input device(s) 126 may all be separate stand alone units. On the other hand, for a tablet arrangement, display 124 may be a touch sensitive display screen that includes user input device(s) 126, and player 122 may be a computing platform with a soft keyboard that also includes one of the user input device(s) 126. Further, display 124 and player 122 may be integrated within a single form factor. Similarly, for a smartphone arrangement, player 122, display 124 and user input device(s) 126 may be likewise integrated.

In various embodiments, in addition to other input device(s) 126, the content consumption device may also interact with a microphone 150. In various embodiments, the microphone may be configured to provide input audio signals, such as those received from a speech sample captured from a user. In various embodiments, the user interface engine 136 may be configured to perform speech recognition on the captured speech sample in order to identify one or more spoken words in the captured speech sample. In various embodiments, the user interface module 136 may be configured to perform one or more of the named-entity-based speech recognitions described herein.

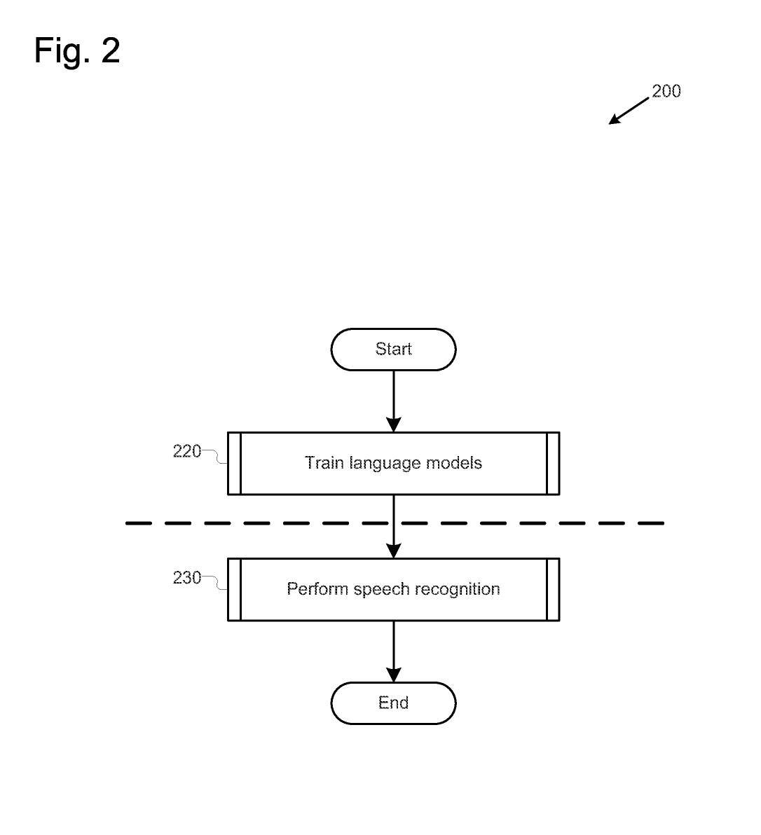

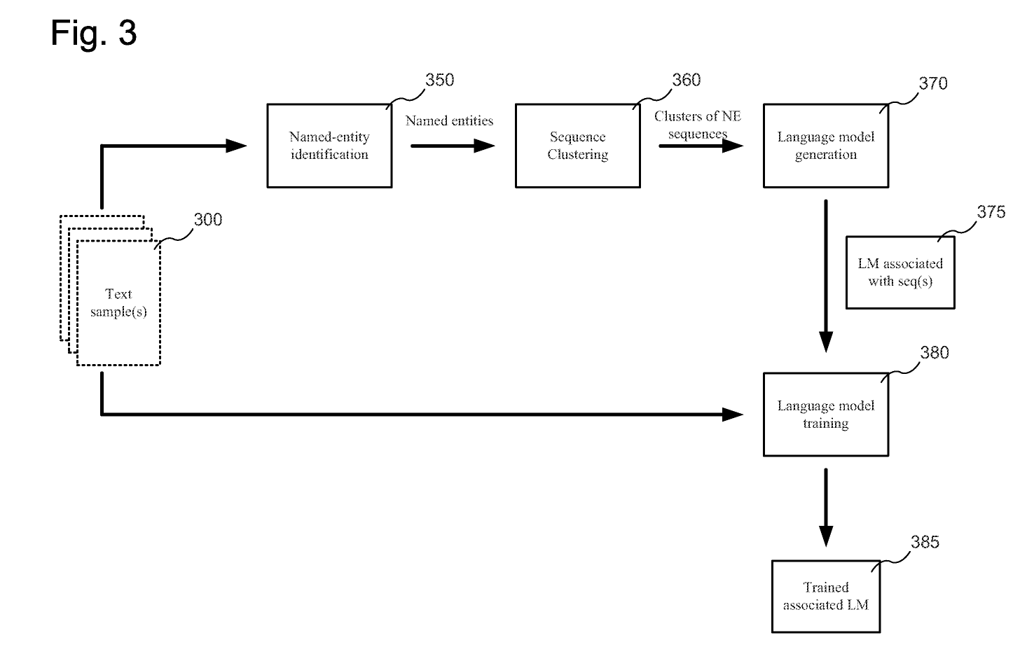

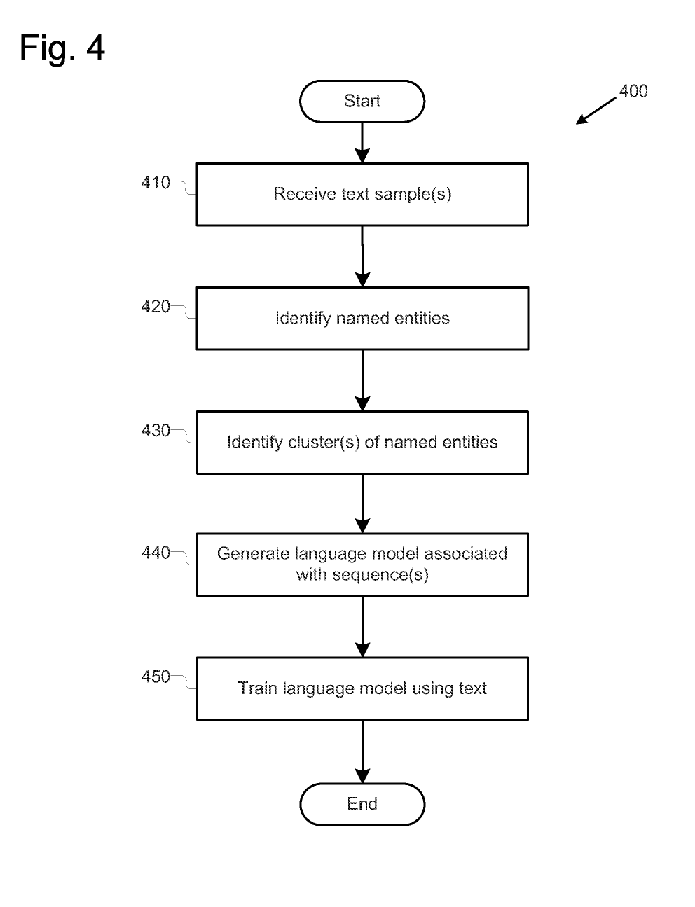

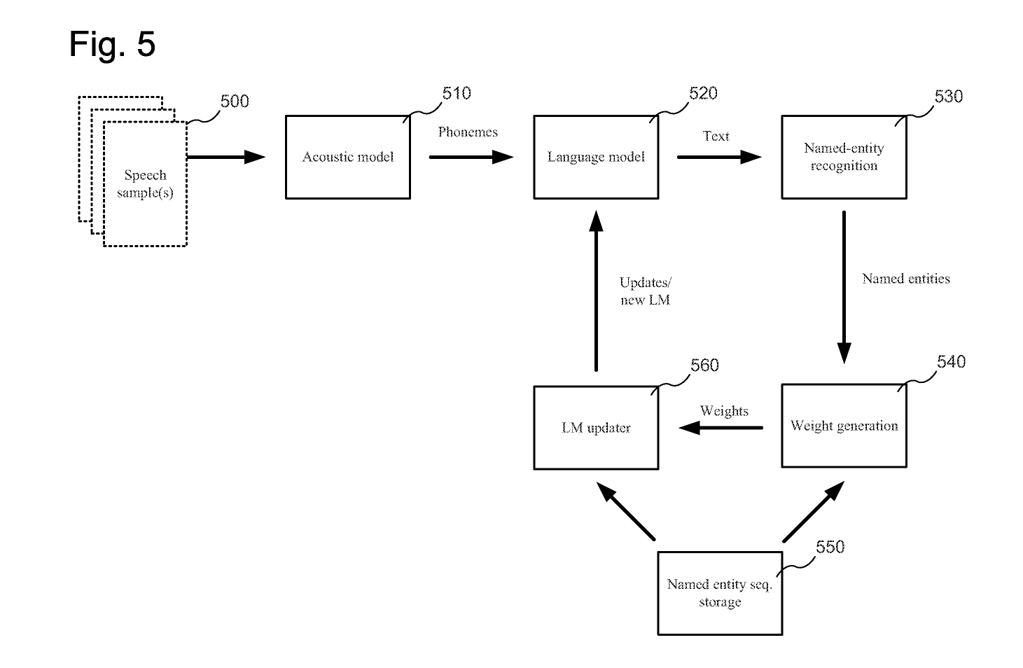

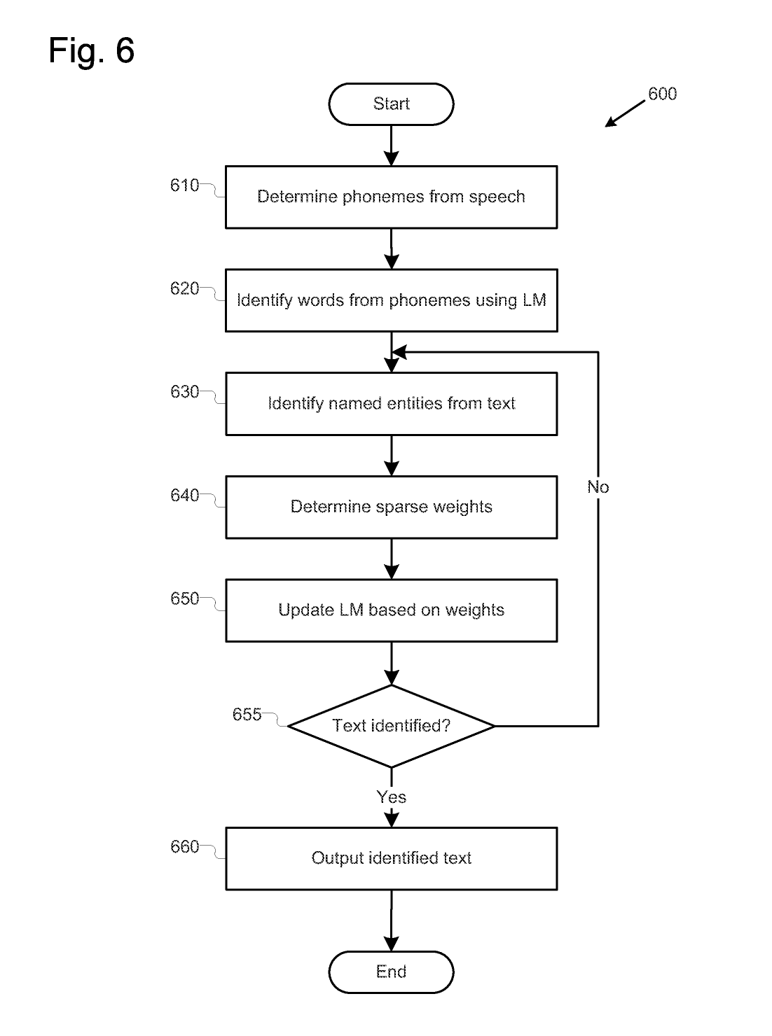

Referring now to FIG. 2, an example process 200 for performing speech recognition may be illustrated in accordance with various embodiments. While FIG. 2 illustrates particular example operations for process 200, in various embodiments, process 200 may include additional operations, omit illustrated operations, and/or combine illustrated operations. In various embodiments, the actions of process 200 may be performed by a user interface module 136 and/or other computing modules or devices. In various embodiments, process 200 may begin at operation 220, where language models that are associated with sequences of named entities may be trained. In various embodiments, operation 220 may be performed by an entity other than the content consumption device 108, such the trained language models may be later utilized during operation of the content consumption device 108. Particular implementations of operation 220 may be described below with reference to FIGS. 3 and 4. Next, at operation 230, the content consumption device 108 may perform speech recognition on captured speech samples. In various embodiments, the user interface module 135 may perform embodiments of operation 230. Particular implementations of operation 230 may be described below with reference to FIGS. 5 and 6. After performance of operation 230, process 200 may end.

Referring now to FIG. 3, an example arrangement 390 for training language models associated with sequences of named entities is illustrated in accordance with various embodiments. In various embodiments, the modules and activities described with reference to FIG. 3 may be implemented on a computing device, such as those described herein.

In various embodiments, language models may be trained with reference to one or more text sample(s) 300. In various embodiments, the text sample(s) 300 may be indicative of commands that may be used by users of the content consumption device 108. In other embodiments, the text sample(s) 300 may include one or more named entities that may be used by a user of the content consumption device 108. Thus, in various embodiments, the text sample(s) 300 may include text content that is not necessarily directed toward usage of the content consumption device 108, but may nonetheless be associated with content that may be consumed by the content consumption device 108.

In various embodiments, during operation 220 of process 200, a named-entity identification module 350 may receive the one or more text sample(s) as input. In various embodiments, the named-entity identification module 350 may be configured to identify one or more named entities from the input text sample(s) 350. In various embodiments, identification of named entities may be performed by the named-entity identification module 350 according to known techniques. After named entities are identified, the named entities may be provided as input to a sequence clustering module 360, which may be configured to cluster named entities into one or more clusters of named entities. In various embodiments, the sequence clustering module 360 may be configured to cluster named entities according to a sequence in which they appear in the text, thus providing sequences of named entities which may be associated with language models as they are trained.

As an example, consider a text sample 300 that includes a sentence “Angelina Jolie and Brad Pitt are one of Hollywood's most famous couples.” In various embodiments, the named-entity identification module 350 may identify “Angelina Jolie,” “Brad Pitt” and “Hollywood” as named entities. In various embodiments, the sequence clustering module 360 may cluster (“Angelina Jolie”, “Brad Pitt”) as a first sequenced cluster and (“Hollywood”) as a second cluster. Thus, two sequences of named entities may be identified for the sample sentence.

In various embodiments, a language module generator 370 may be configured to generate (or other wise provide) a language model 375 that is to be associated with the identified cluster of named entities. In various embodiments, language models 375 may be configured to identify text based on a list of phonemes obtained from captured speech samples. In various embodiments, the generated language model 375 may, after being associated with sequences of named entities, be trained on the text sample(s) 300, such as through the operation of a language model training module 380. In various embodiments, the language model training module 380 may be configured to train the generated language model according to known techniques. In various embodiments, the language model may be trained utilizing text in addition to or in lieu of the one or more text sample(s) 300. As a result of this training, in various embodiments, the language model training module 380 may produce a trained language model 385 associated with one or more sequences of named entities.

Referring now to FIG. 4, an example process 400 for training language models associated with sequences of named entities is illustrated in accordance with various embodiments. While FIG. 4 illustrates particular example operations for process 400, in various embodiments, process 400 may include additional operations, omit illustrated operations, and/or combine illustrated operations. In various embodiments, process 400 may be performed to implement operation 220 of process 200 of FIG. 2. In various embodiments, process 400 may be performed by one or more entities illustrated in FIG. 3.

The process may begin at operation 410, where one or more text sample(s) 300 may be received. Next, at operation 420, the named-entity identification module 350 may identify named entities in the one or more text sample(s).

Next, at operation 430, the sequence clustering module 360 may identify one or more sequences of named entities. In various embodiments, these clustered sequences of named entities may retain sequential information from the original text samples from which they are identified, thus improving later speech recognition. In various embodiments, one technique that may be used for identifying sequences may be a hidden Markov model (“HMM”). As may be known, an HMM may operate like a probabilistic state machine that may work to determine probabilities of transitions between hidden, or unobservable, states based on observed sequences of named entities. Thus, for example, given new text and its corresponding entities, the sequence clustering module 260 may identify the most likely hidden state, or cluster of NEs.

Next, at operation 440, the language model generation 370 may generate a language model 375 that is associated with one or more of the identified sequences of named entities. Next, at operation 450, the language model training module 380 may train the language model 375, such as based on the one or more text sample(s) 300, to produce a trained language model 385 that is associated with the identified sequences of named entities. The process may then end.

Referring now to FIG. 5, an example arrangement 590 for speech recognition using language models associated with sequences of named entities is illustrated, in accordance with various embodiments. In various embodiments, the entities illustrated in FIG. 5 may be implemented by the user interface engine 136 of the content consumption device 108, such as for recognition of user-spoken commands to the content consumption device 108. In various embodiments, one or more speech sample(s) 500 may be received as input into an acoustic model 510. In various embodiments, the one or more speech sample(s) 500 may be captured by the content consumption device 108, such as using the microphone 150. In various embodiments, the acoustic model 510 may be configured to identify one or more phonemes from the input speech, such as according to known techniques.

In various embodiments, the phonemes identified by the acoustic model 510 may be received as input to a language model 520, which may identify one or more words from the phonemes. While, in various embodiments, the language model 520 may be configured to identify text according to known techniques, in various embodiments, the language module 520 may be associated with one or more sequences of named entities in order to provide more accurate identification of text. In various embodiments, through operation of additional entities described herein, the language model 520 may be modified or replaced by a language module 520 that is specifically associated with named entities found in the speech sample(s) 500. Thus, in various embodiments, the text identified by the language model 520 may be used as input to a named-entity recognition module 530. In various embodiments, this named-entity identification module 530 may be configured to identify one or more named entities out of the input text.

In various embodiments, these named entities may be used as input to a weight generation module 540. In various embodiments, the weights generated by the weight generation module 540 may be generated as input to a language model updater module 560. In various embodiments, the language model updater module 560 may be configured to update or replace the language model 520 to a language model that is associated with one or more sequences of named entities identified by the named entity identification module 530. In various embodiments, this updating may be based on hidden Markov model sequence clustering. In various embodiments, once a sequence of entities is extracted by named entity recognition, a probability may be computed that the extracted sequence belongs to various clusters. Various embodiments, may include known techniques for computing these probabilities. In various embodiments, once the probabilities are computed, the probabilities themselves may be used as weights for obtaining a new language model. Existing language models that correspond to particular cluster may be weighed by each of the corresponding weights and summed to generate a new model. Alternatively, if the best probability for any cluster is not sufficient, parts or all of a previous language model may be retained. In some embodiments, a determination may be made by comparing probabilities for the previous model to the summed weighed new model. Thus, if the best cluster is sufficiently good, the new model based on entity clusters may be used, and if it is insufficient, the updated model may rely on the old model.

In various embodiments, the weights may be generated as sparse weights. In such embodiments, the weight generation module 540 may assume that, for a set of text identified by the language model 520, that only one cluster, or a few clusters, of named entities is associated with that text. Thus, sparse weights may improve identification of a language model to update the current language model 520 with. In various embodiments, clusters with particularly low probabilities that fall below a particular threshold may be ignored or removed. This sparsifying technique may be used both for learning the clusters by incorporating a threshold when training an HMM. By working to ensure that observation probabilities are sparse, any particular state (or cluster) of the HMM can represent only a few different observations (entities). In a sense, sparsity may force each cluster to specialize in a few entities without operating a maximum efficiency on others, rather than all clusters trying to best represent every entity.

Sparsifying may also be used when determining weights. Known sparsifying techniques may be used such that, given an observation sequence of entities, a most likely sequence of clusters may be found such that there are only a few clusters. Other known sparsifying techniques may be utilized. One can use any combination of the techniques outlined above to obtain sparse weights.

In various embodiments, the language model updater module 560 and the weight generation modules 540 may communicate with a named entity sequence storage 550, which may be configured to store one or more sequences of named entities. Thus, the weight generation module 540 may be configured to determine weights for various sequences of named entities stored in the named entity sequence storage 550 and to provide these to the language model updater module 560. The language model updater module 560 may then identify the language model associated with the highest-weighed sequences of named entities for updating of the language model 520.

In various embodiments, after updating of the language model 520, additional text may be identified by the updated language model 520. Further named entities may then be identified by the named entity identification module 530 and further weights and updates to the language model may be generated in order to further refine the speech recognition performed by the language model. In various embodiments, this refinement may continue until the speech converges on particular text, as may be understood. In various embodiments, a performance threshold may be utilized to determine whether convergence has occurred, as may be understood.

Referring now to FIG. 6, an example process for performing speech recognition using language models associated with sequences of named entities is illustrated, in accordance with various embodiments. While FIG. 6 illustrates particular example operations for process 600, in various embodiments, process 600 may include additional operations, omit illustrated operations, and/or combine illustrated operations. In various embodiments, process 600 may be performed to implement operation 230 of process 200 of FIG. 2. In various embodiments, process 600 may be performed by one or more entities illustrated in FIG. 5.

The process may begin at operation 610, where the acoustic model 510 may determine one or more phonemes in the one or more speech sample(s) 500. Next, at operation 630, a language model 520 may identify text from the phonemes. Next, at operation 630, the named entity identification module 530 may identify one or more named entities from the identified text. Next, at operation 640, the weight generation module 540 may determine one or more sparse weights associated with the identified named entities. In various embodiments, these weights maybe based on one or more sequences of named entities that have been previously stored.

Next, at operation 650, the language model 520 may be updated or replaced based on the weights. Thus, in various embodiments the language model 520 may be replaced with a language model associated with a sequence of named entities that has the highest weight determined by the weight generation module 540.

Next, at decision operation 655, the updated language model 520 may be used to determine whether the text has been identified, such as whether the text is converging sufficiently to satisfy a predetermined threshold. In various embodiments, the language model may be used to along with other features, such as acoustic score, n-best hypotheses, etc., to estimate a confidence score. If the text is not converging, then the process may repeat at operation 630, where additional named entities may be identified. If, however, the text has sufficiently converged, then at operation 660, the identified text may be output. In various embodiments, the output text may then be utilized as commands to the content consumption device. In other embodiments, the identified text may simply be output in textual form. The process may then end.

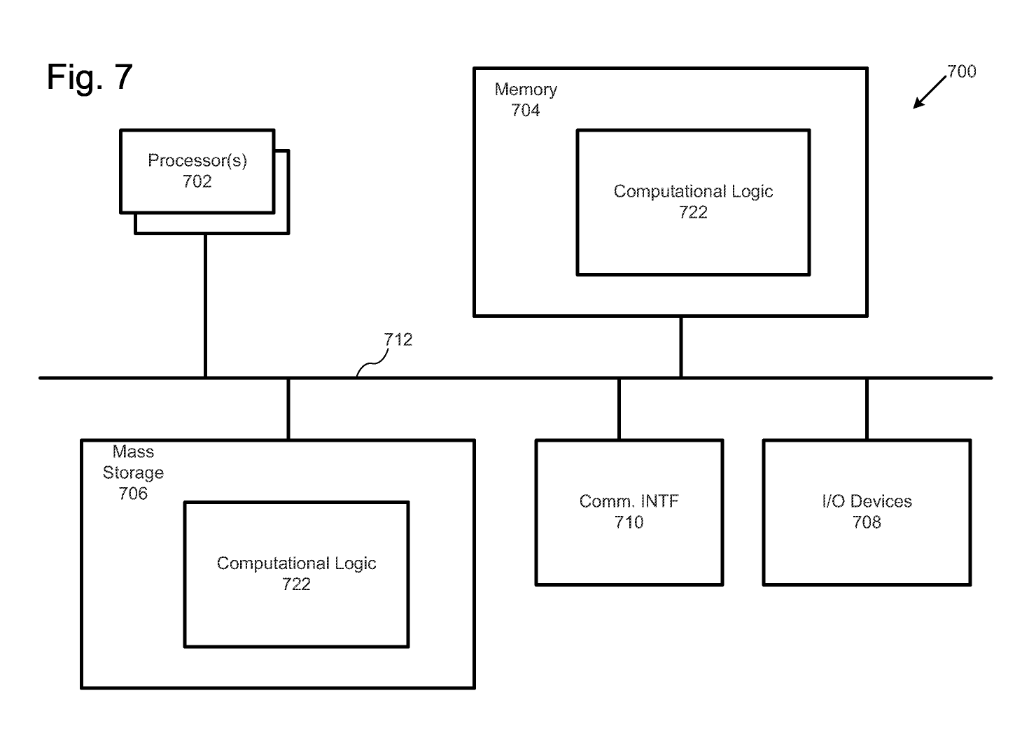

Referring now to FIG. 7, an example computer suitable for practicing various aspects of the present disclosure, including processes of FIGS. 2, 4, and 6, is illustrated in accordance with various embodiments. As shown, computer 700 may include one or more processors or processor cores 702, and system memory 704. For the purpose of this application, including the claims, the terms “processor” and “processor cores” may be considered synonymous, unless the context clearly requires otherwise. Additionally, computer 700 may include mass storage devices 706 (such as diskette, hard drive, compact disc read only memory (CD-ROM) and so forth), input/output devices 708 (such as display, keyboard, cursor control, remote control, gaming controller, image capture device, and so forth) and communication interfaces 710 (such as network interface cards, modems, infrared receivers, radio receivers (e.g., Bluetooth), and so forth). The elements may be coupled to each other via system bus 712, which may represent one or more buses. In the case of multiple buses, they may be bridged by one or more bus bridges (not shown).

Each of these elements may perform its conventional functions known in the art. In particular, system memory 704 and mass storage devices 706 may be employed to store a working copy and a permanent copy of the programming instructions implementing the operations associated with content consumption device 108, e.g., operations associated with camera control such as shown in FIGS. 2, 4, and 6. The various elements may be implemented by assembler instructions supported by processor(s) 602 or high-level languages, such as, for example, C, that can be compiled into such instructions.

The permanent copy of the programming instructions may be placed into permanent storage devices 706 in the factory, or in the field, through, for example, a distribution medium (not shown), such as a compact disc (CD), or through communication interface 710 (from a distribution server (not shown)). That is, one or more distribution media having an implementation of the agent program may be employed to distribute the agent and program various computing devices.

The number, capability and/or capacity of these elements 710-712 may vary, depending on whether computer 700 is used as a content aggregator/distributor server 104 or a content consumption device 108 (e.g., a player 122). Their constitutions are otherwise known, and accordingly will not be further described.

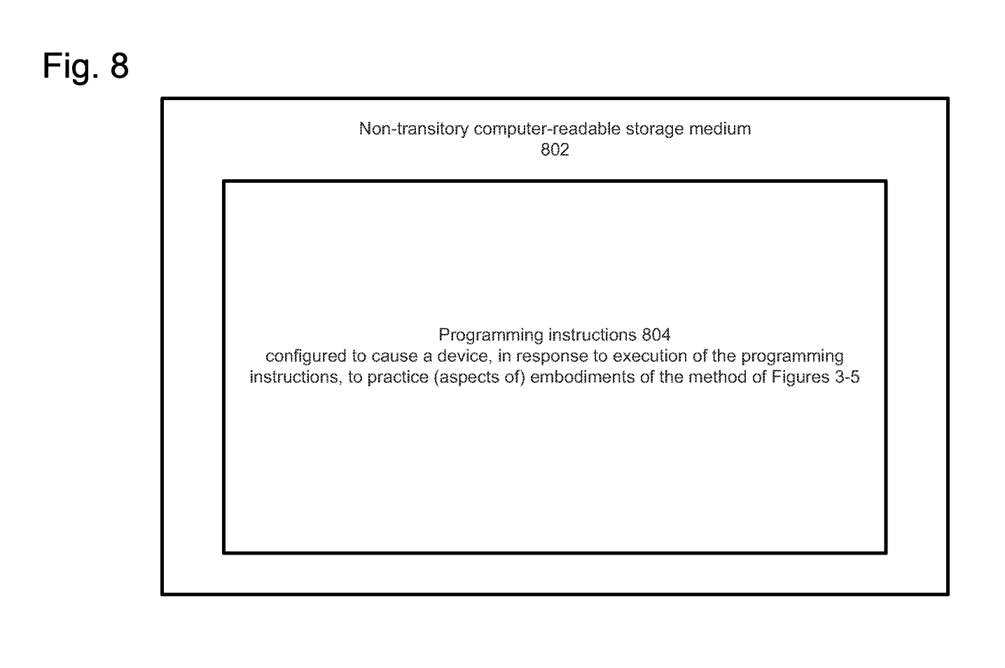

FIG. 8 illustrates an example least one computer-readable storage medium 802 having instructions configured to practice all or selected ones of the operations associated with content consumption device 108, e.g., operations associated with speech recognition, earlier described, in accordance with various embodiments. As illustrated, least one computer-readable storage medium 802 may include a number of programming instructions 804. Programming instructions 804 may be configured to enable a device, e.g., computer 700, in response to execution of the programming instructions, to perform, e.g., various operations of processes of FIGS. 2, 4, and 6, e.g., but not limited to, to the various operations performed to perform determination of frame alignments. In alternate embodiments, programming instructions 804 may be disposed on multiple least one computer-readable storage media 802 instead.

Referring back to FIG. 7, for one embodiment, at least one of processors 702 may be packaged together with computational logic 722 configured to practice aspects of processes of FIGS. 2, 4, and 6. For one embodiment, at least one of processors 702 may be packaged together with computational logic 722 configured to practice aspects of processes of FIGS. 2, 4, and 6 to form a System in Package (SiP). For one embodiment, at least one of processors 702 may be integrated on the same die with computational logic 722 configured to practice aspects of processes of FIGS. 2, 4, and 6. For one embodiment, at least one of processors 702 may be packaged together with computational logic 722 configured to practice aspects of processes of FIGS. 2, 4, and 6 to form a System on Chip (SoC). For at least one embodiment, the SoC may be utilized in, e.g., but not limited to, a computing tablet.

Various embodiments of the present disclosure have been described. These embodiments include, but are not limited to, those described in the following paragraphs.

Example 1 includes one or more computer-readable storage media including a plurality of instructions configured to cause one or more computing devices, in response to execution of the instructions by the computing device, to facilitate recognition of speech. The instructions may cause a computing device to identify one or more sequences of parts of speech in a speech sample and determine text spoken in the speech sample based at least in part on a language model associated with the one or more identified sequences.

Example 2 includes the one or more computer-readable media of example 1, wherein the parts of speech include named entities.

Example 3 includes the computer-readable media of example 2, wherein the instructions are further configured to cause the one or more computing devices to modify or replace the language model based at least in part on the sequences of named entities.

Example 4 includes the computer-readable media of example 3, wherein the instructions are further configured to cause the one or more computing devices to determine weights for the one or more sequences of named entities.

Example 5 includes the computer-readable media of example 4, wherein the instructions are further configured to cause the one or more computing devices to modify or replace the language model based at least in part on the weights for the one or more sequences of named entities.

Example 6 includes the computer-readable media of example 5, wherein the weights are sparse weights.

Example 7 includes the computer-readable media of example 5, wherein the instructions are further configured to cause the one or more computing devices to repeat the identify, determine weights, modify or replace, and determine text.

Example 8 includes the computer-readable media of example 7, wherein the instructions are further configured to cause the one or more computing devices to repeat until a convergence threshold is reached.

Example 9 includes the computer-readable media of any of examples 2, wherein the instructions are further configured to cause the one or more computing devices to identify sequences of named entities based on text identified by the language model.

Example 10 includes the computer-readable media of example 2, wherein the instructions are further configured to cause the one or more computing devices to determine one or more phonemes from the speech and determine text from the one or more phonemes based at least in part on the language model.

Example 11 includes the computer-readable media of example 2, wherein the language model was trained based on one or more sequences of named entities associated with the language model.

Example 12 includes the computer-readable media of example 11, wherein the language model includes a language model that was trained based on a sample of text that included the one or more sequences of named entities associated with the language model.

Example 13 includes the computer-readable media of example 2, wherein the instructions are further configured to cause the one or more computing devices to receive the speech sample.

Example 14 includes one or more computer-readable storage media including a plurality of instructions configured to cause one or more computing devices, in response to execution of the instructions by the computing device, to facilitate speech recognition. The instructions may cause a computing device to identify one or more sequences of named entities in a text sample and train a language model associated with the one or more sequences of named entities based on in part on the text sample.

Example 15 includes the computer-readable media of example 14, wherein the instructions are further configured to cause the computing device to identify one or more named entities in the text sample, cluster sequences of named entities, and associate a language module with the clustered sequences of named entities.

Example 16 includes the computer-readable media of example 14, wherein the instructions are further configured to cause the computing device to store the associated language model for subsequent speech recognition.

Example 17 includes the computer-readable media of example 14, wherein the language model is associated with a single cluster of named entity sequences.

Example 18 includes the computer-readable media of example 14, wherein the language model is associated with a small number of sequences of named entities.

Example 19 includes an apparatus for facilitating recognition of speech. The apparatus may include one or more computer processors and one or more modules configured to execute on the one or more computer processors. The one or more modules may be configured to identify one or more sequences of named entities in a speech sample and determine text spoken in the speech sample based at least in part on a language model associated with the one or more identified sequences.

Example 20 includes the apparatus of example 19, wherein the one or more modules are further configured to modify or replace the language model based at least in part on the sequences of named entities.

Example 21 includes the apparatus of example 20, wherein the one or more modules are further configured to determine weights for the one or more sequences of named entities.

Example 22 includes the apparatus of example 21, wherein the one or more modules are further configured to modify or replace the language model based at least in part on the weights for the one or more sequences of named entities.

Example 23 includes the apparatus of example 22, wherein the weights are sparse weights.

Example 24 includes the apparatus of example 22, wherein the one or more modules are further configured to repeat the identify, determine weights, modify or replace, and determine text.

Example 25 includes the apparatus of example 24, wherein the one or more modules are further configured to repeat until a convergence threshold is reached.

Example 26 includes the apparatus of any of examples 19-25, wherein the one or more modules are further configured to identify sequences of named entities based on text identified by the language model.

Example 27 includes the apparatus of any of examples 19-25, wherein the one or more modules are further configured to determine one or more phonemes from the speech and determine text from the one or more phonemes based at least in part on the language model.

Example 28 includes the apparatus of any of examples 19-25, wherein the language model was trained based on one or more sequences of named entities associated with the language model.

Example 29 includes the apparatus of example 28, wherein the language model includes a language model that was trained based on a sample of text that included the one or more sequences of named entities associated with the language model.

Example 30 includes the apparatus of any of examples 19-25, wherein the instructions are further configured to cause the one or more computing devices to receive the speech sample.

Example 31 includes a computer-implemented method for facilitating recognition of speech. The method may include identifying, by a computing device, one or more sequences of named entities in a speech sample and determining, by the computing device, text spoken in the speech sample based at least in part on a language model associated with the one or more identified sequences.

Example 32 includes the method of example 31, further including modifying or replacing, by the computing device, the language model based at least in part on the sequences of named entities.

Example 33 includes the method of example 32, further including determining, by the computing device, weights for the one or more sequences of named entities.

Example 34 includes the method of example 33, wherein modify or replace the language model includes modify or replace the language model based at least in part on the weights for the one or more sequences of named entities.

Example 35 includes the method of example 34, wherein the weights are sparse weights.

Example 36 includes the method of example 34, further including repeating, by the computing device, the identify, determine weights, modify or replace, and determine text.

Example 37 includes the method of example 36, wherein repeating includes repeating until a convergence threshold is reached.

Example 38 includes the method of any of examples 31-37, further including identifying, by the computing device, sequences of named entities based on text identified by the language model.

Example 39 includes the method of any of examples 31-37, further including determining, by the computing device, one or more phonemes from the speech and determining, by the computing device, text from the one or more phonemes based at least in part on the language model.

Example 40 includes the method of any of examples 31-37, wherein the language model includes a language model that was trained based on one or more sequences of named entities associated with the language model.

Example 41 includes the method of example 40, wherein the language model was trained based on a sample of text that included the one or more sequences of named entities associated with the language model.

Example 42 includes the method of any of examples 31-37, further including receiving, by the computing device, the speech sample.

Computer-readable media (including least one computer-readable media), methods, apparatuses, systems and devices for performing the above-described techniques are illustrative examples of embodiments disclosed herein. Additionally, other devices in the above-described interactions may be configured to perform various disclosed techniques.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. One or more computer-readable storage media comprising a plurality of instructions configured to cause one or more computing devices, in response to execution of the instructions by the computing device, to:
identify one or more sequences of parts of speech in a speech sample;
determine text spoken in the speech sample based at least in part on a language model associated with the one or more identified sequences.

2. The one or more computer-readable media of claim 1, wherein the parts of speech comprise named entities.

3. The computer-readable media of claim 2, wherein the instructions are further configured to cause the one or more computing devices to modify or replace the language model based at least in part on the sequences of named entities.

4. The computer-readable media of claim 3, wherein the instructions are further configured to cause the one or more computing devices to determine weights for the one or more sequences of named entities.

5. The computer-readable media of claim 4, wherein the instructions are further configured to cause the one or more computing devices to modify or replace the language model based at least in part on the weights for the one or more sequences of named entities.

6. The computer-readable media of claim 5, wherein the weights are sparse weights.

7. The computer-readable media of claim 5, wherein the instructions are further configured to cause the one or more computing devices to repeat the identify, determine weights, modify or replace, and determine text.

8. The computer-readable media of claim 7, wherein the instructions are further configured to cause the one or more computing devices to repeat until a convergence threshold is reached.

9. The computer-readable media of any of claim 2, wherein the instructions are further configured to cause the one or more computing devices to identify sequences of named entities based on text identified by the language model.

10. The computer-readable media of claim 2, wherein the instructions are further configured to cause the one or more computing devices to:
determine one or more phonemes from the speech; and
determine text from the one or more phonemes based at least in part on the language model.

11. The computer-readable media of claim 2, wherein the language model was trained based on one or more sequences of named entities associated with the language model.

12. The computer-readable media of claim 11, wherein the language model comprises a language model that was trained based on a sample of text that included the one or more sequences of named entities associated with the language model.

13. The computer-readable media of claim 2, wherein the instructions are further configured to cause the one or more computing devices to receive the speech sample.

14. One or more computer-readable storage media comprising a plurality of instructions configured to cause one or more computing devices, in response to execution of the instructions by the computing device, to:
identify one or more sequences of named entities in a text sample;
train a language model associated with the one or more sequences of named entities based on in part on the text sample.

15. The computer-readable media of claim 14, wherein the instructions are further configured to cause the computing device to:
identify one or more named entities in the text sample;
cluster sequences of named entities; and
associate a language module with the clustered sequences of named entities.

16. The computer-readable media of claim 14, wherein the instructions are further configured to cause the computing device to store the associated language model for subsequent speech recognition.

17. The computer-readable media of claim 14, wherein the language model is associated with a single cluster of named entity sequences.

18. The computer-readable media of claim 14, wherein the language model is associated with a small number of sequences of named entities.

19. An apparatus, comprising:
one or more computer processors; and
one or more modules configured to execute on the one or more computer processors to:
identify one or more sequences of named entities in a speech sample;
determine text spoken in the speech sample based at least in part on a language model associated with the one or more identified sequences.

20. The apparatus of claim 19, wherein the one or more modules are further configured to modify or replace the language model based at least in part on the sequences of named entities.

21. The apparatus of claim 20, wherein the one or more modules are further configured to:
determine weights for the one or more sequences of named entities; and
modify or replace the language model based at least in part on the weights for the one or more sequences of named entities.

22. The apparatus of claim 19, wherein the one or more modules are further configured to identify sequences of named entities based on text identified by the language model.

23. A computer-implemented method, comprising:
identifying, by a computing device, one or more sequences of named entities in a speech sample;
determining, by the computing device, text spoken in the speech sample based at least in part on a language model associated with the one or more identified sequences.

24. The method of claim 23, further comprising modifying or replacing, by the computing device, the language model based at least in part on the sequences of named entities.

25. The method of claim 23, further comprising identifying, by the computing device, sequences of named entities based on text identified by the language model.
